(19) United States
(12) Patent Application Publication
(10) Pub. No.: US 2008/0062370 A1
(43) Pub. Date: Mar. 13, 2008

(54) LIQUID CRYSTAL DISPLAY

(76) Inventor: Won-Sang Park, Yongin-si (KR)

Correspondence Address: F. CHAU & ASSOCIATES, LLC, 130 WOODBURY ROAD, WOODBURY, NY, 11797, US

(21) Appl. No.: 11/751,749

(22) Filed: May 22, 2007

(30) Foreign Application Priority Data
May 24, 2006 (KR) 10-2006-0046550

(51) Int. Cl. G02F 1/1343

(52) U.S. Cl. 349/144; 349/139

(57) ABSTRACT

A liquid crystal display (LCD) includes a first substrate, and a pixel electrode formed on the first substrate and including first and second sub-pixel electrodes, wherein the first and second sub-pixel electrodes are connected to each other via a connection portion and a length of the connection portion is greater than or equal to about 10 μm.

### CROSS-REFERENCE TO RELATED APPLICATION

This application claims priority to and the benefit of Korean Patent Application No. 10-2006-0046550 filed in the Korean Intellectual Property Office on May 24, 2006, the entire contents of which are incorporated herein by reference.

### BACKGROUND OF THE INVENTION

(a) Technical Field

The present invention relates to a liquid crystal display (LCD).

(b) Discussion of the Related Art

A liquid crystal display (LCD), one of commonly used flat panel displays, includes two display panels on which field generating electrodes such as pixel electrodes and a common electrode are respectively formed, and a liquid crystal layer interposed therebetween. In the LCD, a voltage is applied to the field generating electrodes to generate an electric field in the liquid crystal layer to thereby determine an alignment of liquid crystal molecules of the liquid crystal layer and control polarization of incident light, thereby resulting in display of images.

Of LCDs, a vertically aligned mode LCD, in which liquid crystal molecules are arranged such that their longer axes are perpendicular to display panels when no electric field is applied thereto, has been developed, and has a relatively high contrast ratio and wide reference viewing angle.

In order to implement a wide reference viewing angle in the vertical alignment mode LCD, a method for forming cut-out portions on the field generating electrode and a method for forming protrusions on the field generating electrode have been used. Because the cut-out portions and the protrusions control the tilt direction of liquid crystal molecules, the tilt direction of the liquid crystal molecules can be formed in several directions by appropriately disposing the cut-out portions and the protrusions in order to widen the reference viewing angle.

However, liquid crystals positioned at a corner or a connection portion are not affected by a fringe field formed by upper and lower cut-out portions. Thus, when the LCD is driven, the liquid crystals at the corner or the connection portion may he aligned in arbitrary directions.

When liquid crystals are aligned in arbitrary directions, instantaneous residual images can be generated due to collisions between liquid crystals occurring at arbitrary portions of the display.

Therefore, there is a need to minimize the amount of liquid crystal molecules that are not affected by the fringe field and, thereby minimize the number of residual images caused by liquid crystal collisions, while increasing aperture ratio of the LCD.

### SUMMARY OF THE INVENTION

In accordance with an exemplary embodiment of the present invention, a liquid crystal display (LCD) includes a first substrate, and a pixel electrode formed on the first substrate and including first and second sub-pixel electrodes, wherein the first and second sub-pixel electrodes are connected to each other via a connection portion and a length of the connection portion is greater than or equal to about 10 μm.

The length of the connection portion can be within the range of about 20 μm to about 28 μm.

A width of the connection portion can be less than or equal to about 10 μm.

The width of the connection portion can be within the range of about 6 μm to about 7 μm.

The LCD may further include a storage electrode formed between the first and second sub-pixel electrodes.

The LCD may further include a gate line, a data line crossing the gate line and having a source electrode, and a drain electrode facing the source electrode. The drain electrode and the storage electrode may overlap each other.

The pixel electrode and the drain electrode may be connected at a portion where the storage electrode and the drain electrode overlap.

A branch portion may extend from the connection portion, and the pixel electrode and the drain electrode may be connected at the portion where the pixel electrode and the drain electrode overlap with the branch portion.

The first and second sub-pixel electrodes may each have rounded corners.

The LCD may further include a second substrate facing the first substrate and a common electrode formed on the second substrate, and a plurality of tilt control portions may be formed on the common electrode, wherein a tilt control portion faces the center of the first or second sub-pixel electrode.

The tilt control portions may be circular cut-out portions.

The LCD may further include a light blocking member formed on the second substrate such that it overlaps with the gate line.

The area of the first sub-pixel electrode and the area of the second sub-pixel electrode may be substantially the same.

### BRIEF DESCRIPTION OF THE DRAWINGS

The present invention will become more apparent by describing exemplary embodiments thereof in more detail in reference to the accompanying drawings, in which:

FIG. 1 is a layout view of a liquid crystal display (LCD) according to an exemplary embodiment of the present invention.

FIG. 2 is a layout view of a thin film transistor (TFT) array panel of the LCD in FIG. 1.

FIG. 3 is a layout view of a common electrode panel of the LCD in FIG. 1.

FIGS. 4 to 6 are cross-sectional views taken along lines IV-IV, V-V, and VI-VI of FIG. 1, respectively.

### DETAILED DESCRIPTION OF EMBODIMENTS

Exemplary embodiments of the present invention will now be described more fully hereinafter with reference to the accompanying drawings. This invention may, however, be embodied in many different forms and should not be construed as limited to the embodiments set forth herein.

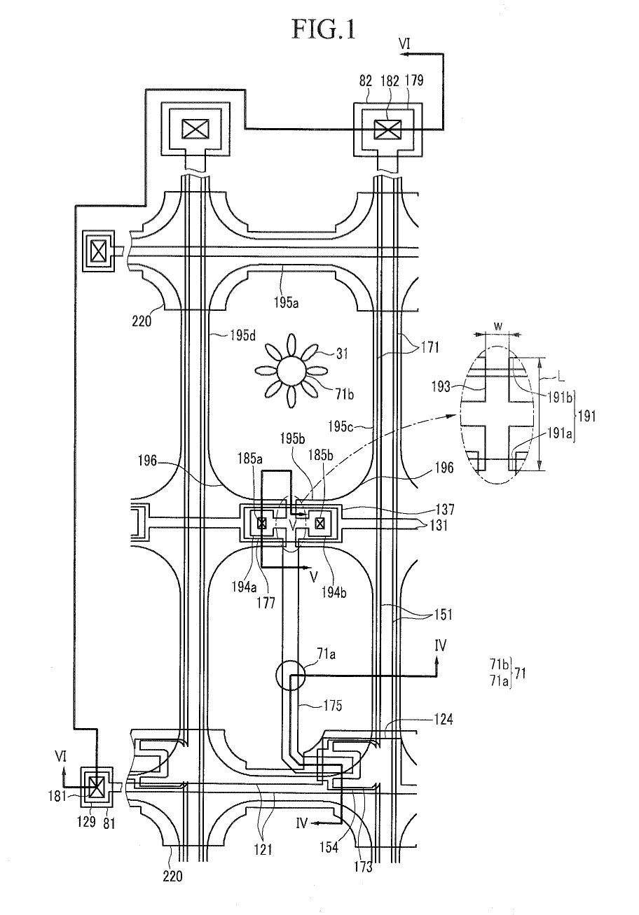

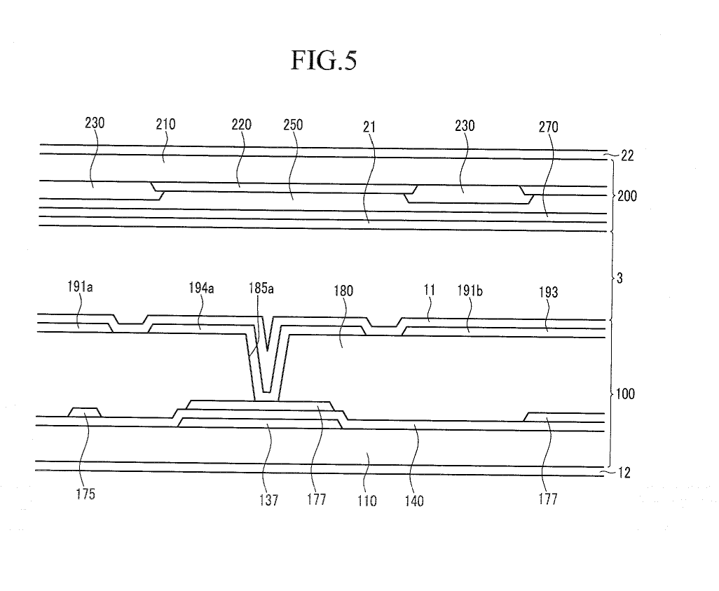

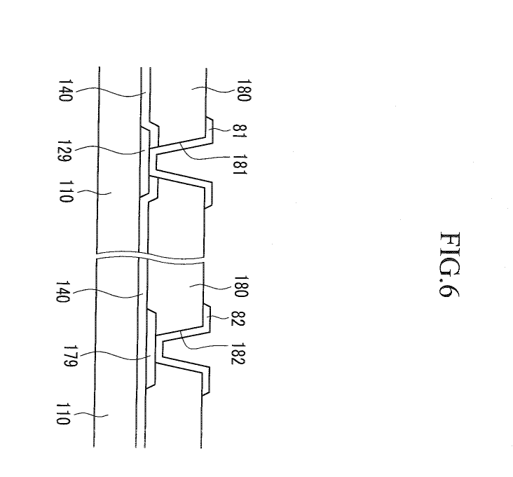

In the drawings, the thickness of layers, films, panels, regions, may be exaggerated for clarity. Like reference numerals may designate like elements throughout the specification. It will be understood that when an element such as a layer, film, region, or substrate is referred to as being “on” another element, it can be directly on the other element or intervening elements may also be present. A liquid crystal display (LCD) according to an exemplary embodiment of the present invention will be described in more detail with reference to FIGS. 1 to 6.

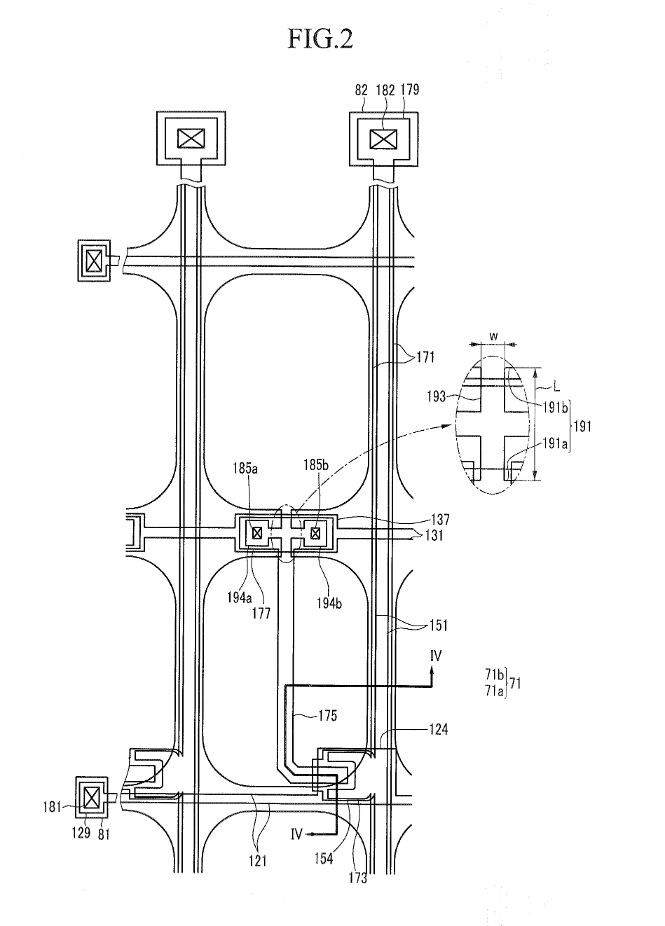

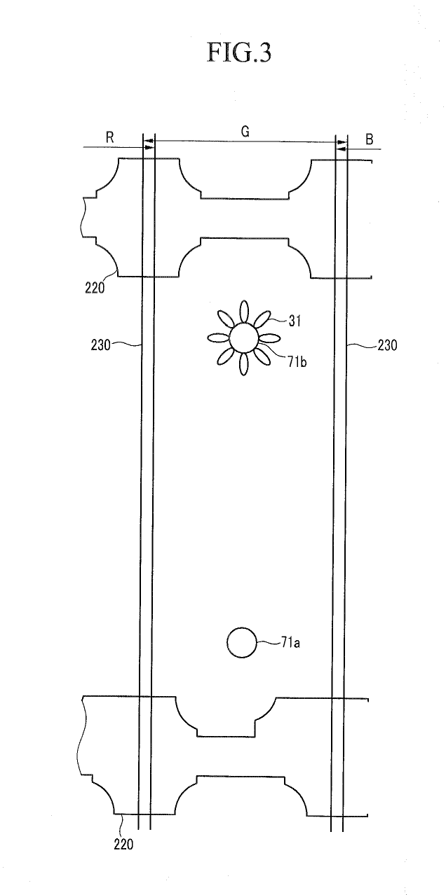

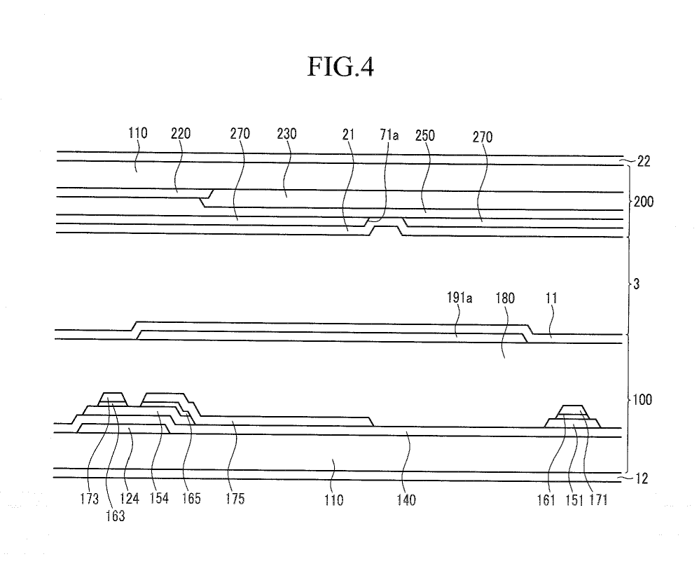

FIG. 1 is a layout view of an LCD according to an exemplary embodiment of the present invention, FIG. 2 is a layout view of a thin film transistor (TFT) array panel of the LCD in FIG. 1, FIG. 3 is a layout view of a common electrode panel of the LCD in FIG. 1, and FIGS. 4 to 6 are cross-sectional views taken along lines IV-IV, V-V, and VI-VI of FIG. 1, respectively.

With reference to FIGS. 1 to 6, the LCD includes a lower panel 100 and an upper panel 200 that face each other, and a liquid crystal layer 3 interposed between the lower and upper panels 100 and 200.

First, the lower panel 100 will be described.

With reference to FIGS. 1, 2, 4, 5 and 6, a plurality of gate lines 121 and a plurality of storage electrode lines 131 are formed on an insulation substrate 110 made of, for example, transparent glass or plastic.

The gate lines 121 transfer gate signals, and mainly extend in a first direction, for example, the horizontal direction shown in FIG. 1. The gate lines include a plurality of gate electrodes 124 that protrude from the gate lines, for example, in an upward direction as shown in FIG. 1. The gate lines further include an end portion 129 having an increased size with respect to the gate line 121 for a connection with, for example, a different layer or an external driving circuit. A gate driving circuit (not shown) for generating gate signals can be mounted on a flexible printed circuit film (not shown) attached on the substrate 110, directly mounted on the substrate 110, or integrated with the substrate 110. When the gate driving circuit is integrated with the substrate 110, the gate lines 121 can be elongated to be directly connected to the gate driving circuit.

The storage electrode lines 131 receive a certain voltage, and extend substantially parallel with the gate lines 121. The storage electrode lines 131 are positioned between two adjacent gate lines 121, and may be equidistant from the two adjacent gate lines. The storage electrode lines 131 include a storage electrode 137 that extends from the storage electrode line in, for example, upward and downward directions, so that the storage electrode has an increased width with respect to the storage electrode line 131. The storage electrode lines can be modified to have various shapes and dispositions.

The gate lines 121 and the storage electrode lines 131 can include, for example, an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), and/or titanium (Ti). Also, the gate lines 121 and the storage electrode lines 131 can have a multi-layered structure including two conductive layers (not shown) each having different physical properties.

One of the conductive layers can be made of a metal with low resistivity, such as, for example, the aluminum-based metal, the silver-based metal, or the copper-based metal, in order to reduce a signal delay or a voltage drop. The other conductive layer can be made of a material such as, for example, the molybdenum-based metal, chromium, tantalum, or titanium, that has good physical, chemical, and electrical contact characteristics with a different material, for example ITO (indium Tin Oxide) and IZO (Indium Zinc Oxide). Examples of such combination may include a combination of a lower chromium layer and an upper aluminum (alloy) layer, and a combination of a lower aluminum (alloy) layer and an upper molybdenum (alloy) layer. In addition, the gate lines 121 and the storage electrode lines 131 can be made of various other metals or conductors.

The lateral sides of the gate lines 121 and the storage electrode lines 131 are inclined with respect to the surface of the substrate 110, and the inclination angle is, for example, within the range of about 30° to about 80°.

A gate insulating layer 140 made of, for example, silicon nitride (SiNx) or silicon oxide (SiOx), is formed on the gate lines 121 and the storage electrode lines 131.

A plurality of semiconductor stripes 151 made of, for example, hydrogenated amorphous silicon (a-Si) or polycrystalline silicon, are formed on the gate insulating layer 140. The semiconductor stripes 151 extend mainly in a direction perpendicular to the gate lines 121, for example, a vertical direction as shown in FIGS. 1 and 2, and include a plurality of projections 154 that extend toward the gate electrodes 124.

A plurality of ohmic contact stripes 161 and a plurality of ohmic contact islands 165 are formed on the semiconductor stripes 151. The ohmic contact islands 165 can be made of a material such as n+ hydrogenated amorphous silicon in which an n-type impurity such as phosphor is doped with a high density, or silicide. The ohmic contact stripes 161 include a plurality of projections 163, and a projection 163 and an ohmic contact island 165 are disposed across from each other on each projection 154 of the semiconductor stripes 151.

The lateral sides of the semiconductor stripes 151 and the projections 154 and the lateral sides of the projections 163 and the ohmic contact islands 165 are inclined with respect to the surface of the substrate 110, and the inclination angle is, for example, within the range of about 30° to about 80°.

A plurality of data lines 171 and a plurality of drain electrodes 175 are formed on the projections 163 and the ohmic contact islands 165.

The data lines 171 transfer data signals and extend perpendicular to the gate lines 121, for example, mainly in a vertical direction to cross the gate lines 121 as shown in FIGS. 1 and 2. Each data line 171 includes a plurality of source electrodes 173 extending toward the gate electrodes 124 and an end portion 179 having an increased width for a connection with, for example, a different layer or an external driving circuit. The data driving circuit (not shown) can be mounted on a flexible printed circuit film (not shown) attached on the substrate 110, directly mounted on the substrate 110, or integrated with the substrate 110. When the data driving circuit is integrated with the substrate 110, the data lines 171 can be elongated to be connected to the data driving circuit.

The drain electrodes 175 are separated from the data lines 171 and face the source electrodes 173 with respect to the gate electrodes 124 centered between the source and data electrodes 173, 175.

Each drain electrode 175 includes a bar-type end portion and a larger end portion. The larger end portion of each drain electrode 175 overlaps with the storage electrode 137, and the bar-type end portion is partially surrounded by the source electrode 173, which is bent like a ring.

A thin film transistor (TFT) includes a gate electrode 124, a source electrode 173, and s drain electrode 175, together with a semiconductor projection 154. A channel of the TFT is formed at the semiconductor projection 154 between the source electrode 173 and the drain electrode 175.

The data lines 171 and the drain electrodes 175 can be made of a refractory metal such as molybdenum, chromium, tantalum, and/or titanium, or their alloys, and can have a multi-layered structure including the refractory metal layer (not shown) and a low-resistance conductive layer (not shown). Examples of the multi-layered structure may include a dual-layer of a lower chromium or molybdenum (alloy) layer and an upper aluminum (alloy) layer, and a triple-layer of a lower molybdenum (alloy) layer, an intermediate aluminum (alloy) layer, and an upper molybdenum (alloy) layer. Also, the data lines 171 and the drain electrodes 175 can be made of various other metals or conductors.

The lateral sides of the data lines 171 and the drain electrodes 175 also may be inclined with respect to the surface of the substrate 110 at, for example, an inclination angle within the range of about 30° to about 80°.

The ohmic contact projections 163 and the ohmic contact islands 165 exist between the lower semiconductor projections 154 and the upper data lines 171 and the drain electrodes 175, in order to lower contact resistance therebetween. Some portions of the semiconductor projections 154 including a portion between the source electrodes 173 and the drain electrodes 175 are exposed without being covered by the data lines 171 and the data electrodes 175.

A passivation layer 180 is formed on the data lines 171 and the drain electrodes 175, and on the exposed portion of the semiconductor projections 154.

The passivation layer 180 is made of, for example, an inorganic insulator or organic insulator, and may have a planarized surface. The organic insulator can be, for example, silicon nitride or silicon oxide. The organic insulator can be formed by mixing PAC (Photo-Active Compound), a resin, and an additive containing a close contacting property improver and a surface active agent in a solvent, and its dielectric constant is, for example, about 4.0 or less. The passivation layer 180 may have a dual-layer structure of a lower inorganic layer and an upper organic layer so that the passivation layer 180 does not harm the exposed portion of the semiconductor projections 154, while still maintaining the desired insulation characteristics of the organic layer.

The passivation layer 180 includes a plurality of contact holes 182, 185a, and 185b exposing the end portions 179 of the data lines 171, and the drain electrodes 175. The passivation layer 180 and the gate insulating layer 140 include a plurality of contact holes 181 exposing the end portions 129 of the gate lines 121.

A plurality of pixel electrodes 191 and a plurality of contact assistants 81 and 82 are formed on the passivation layer 180. The pixel electrodes 191 and the contact assistants 81 and 82 can be made of a transparent conductive material such as ITO or IZO, or a reflective metal such as aluminum, silver, chromium, or their alloys.

Each pixel electrode 191 includes first and second sub-pixel electrodes 191a and 191b. The first and second sub-pixel electrodes 191a and 191b are adjacent each other, and the area of the first sub-pixel electrode 191a and that of the second sub-pixel electrode 191b are substantially the same.

The first and second sub-pixel electrodes 191a are connected by a connection portion 193. The connection portion 193 is formed to be substantially parallel to the data lines 171, and has a length (L) and a width (W). The first and second sub-pixel electrodes 191a and 191b are disposed to be sufficiently away from each other, and the length (L) of the connection portion 193 is about 10 μm or greater, and is, for example, within the range of about 20 μm to about 28 μm. The width (W) of the connection portion 193 is about 10 μm or smaller, and is, for example, within the range of about 6 μm to about 8 μm.

The first and second sub-pixel electrodes 191a and 191b have four main edges 195a, 195b, 195c, and 195d which are substantially parallel to the gate lines 121 or the data lines 171, and four corners 196 thereof are rounded.

Branch portions 194a and 194b are formed at two opposite sides of each connection portion 193. The branch portions 194a and 194b overlap with the storage electrodes 137 and extending portions 177 of the drain electrode 175.

At the branch portions 194a and 194b, each pixel electrode 191 is physically and electrically connected with a drain electrode 175 via contact holes 185a and 185b, and receives a data voltage from a drain electrode 175. The pixel electrodes 191, to which the data voltage has been applied, generate an electric field together with a common electrode 270 of a common electrode panel 200 that receives a common voltage, to thereby control a tilt direction of liquid crystal molecules 31 of the liquid crystal layer 3 between the lower and upper panels 100, 200. Polarization of light that is transmitted through the liquid crystal layer 3 differs depending on the tilt direction of the liquid crystal molecules 31. Each pixel electrode 191 and the common electrode 270 form a capacitor (referred to hereinafter as “liquid crystal capacitor”) to sustain the applied voltage even after the TFT is turned off.

The pixel electrode 191 and an end portion 177 of a drain electrode 175 connected thereto overlap with a storage electrode line 131 including a storage electrode 137, and a capacitor, including the pixel electrode 191 and the drain electrode 175 electrically connected with the pixel electrode 191 overlapping the storage electrode line 131, is called a storage capacitor, which strengthens the voltage storage capability of the liquid crystal capacitor.

The contact assistants 81 and 82 are connected with the end portions 129 of the gate lines 121 and the end portions 179 of the data lines 171 via the contact holes 181 and 182, respectively. The contact assistants 81 and 82 complement adhesion of the end portions 129 of the gate lines 121 and the end portions 179 of the data lines 171 with external devices, and protect the end portions 129 and 179 from damage.

The common electrode panel 200 will now be described in further detail.

With reference to FIGS. 1, 3, and 5, a light blocking member 220 made of transparent glass or plastic is formed on an insulation substrate 210. The light blocking member 220, also called a black matrix, defines a plurality of opening regions facing the pixel electrodes 191 and prevents light leakage between the pixel electrodes 191. The light blocking members 220 extend mainly in the same direction as the gate lines 121, for example, a horizontal direction as shown in FIGS. 1 and 3, to overlap with the gate lines 121.

A plurality of color filters 230 are formed on the substrate 210, which are disposed in the opening regions surrounded by the light blocking members 220. The color filters 230 can be elongated in a direction along the pixel electrodes 191 to form a stripe. Each color filter 230 can display one of the three primary colors of red (R), green (G), and blue (B).

An overcoat 250 is formed on the color filters 230 and the light blocking members 220. The overcoat 250 can be made of an (organic) insulator. The overcoat 250 protects the color filters 230, prevents the color filters 230 from being exposed, and provides a planarized surface.

The common electrode 270 is formed on the overcoat 250. For example, the common electrode 270 is made of a transparent conductor such as ITO or IZO.

A plurality of cut-out portions 71 are formed on the common electrode 270. The cut-out portions 71 include a first cut-out portion 71a and a second cut-out portion 71b. The first and second cut-out portions 71a and 71b have a circular shape, and correspond to the central portion of each of the first and second sub-pixel electrodes 191a and 191b, respectively.

Alignment layers 11 and 21 are coated on an inner surface of the panels 100 and 200, and they can be, for example, vertical alignment layers. Polarizers 12 and 22 are provided on an outer surface of the panels 100 and 200, and the polarization axes of the two polarizers 12 and 22 are perpendicular to each other.

According to an exemplary embodiment, the LCD may further include a phase retardation film (not shown) for compensating for a delay of the liquid crystal layer 3. The LCD may further include a backlight unit (not shown) for providing light to the polarizers 12 and 22, the phase retardation film, the panels 100 and 200, and the liquid crystal layer 3.

The liquid crystal layer 3 has negative dielectric anisotropy, and liquid crystal molecules 31 of the liquid crystal layer 3 are aligned such that their longer axes are substantially perpendicular to the surfaces of the two panels 100 and 200 when there is no electric field. Accordingly, incident light is blocked, rather than passing through the crossed polarizers 12 and 22.

When a common voltage is applied to the common electrode 270 and a data voltage is applied to the pixel electrodes 191, an electric field is generated to be substantially perpendicular to the surfaces of the panels 100 and 200. The pixel electrodes 191 and the common electrode 270 may be collectively referred to as “field generating electrodes”. The tilt directions of the liquid crystal molecules 31 are changed in response to the electric field such that their longer axes become perpendicular to the direction of the electric field.

The cut-out portions 71a and 71b of the field generating electrodes 191 and 270 and the edges of the pixel electrodes 191 distort the electric field to create a horizontal component that determines a tilt direction of the liquid crystal molecules 31. The horizontal component of the electric field is substantially perpendicular to the cut-out portions 71a and 71b and the edge of the pixel electrodes 191.

With reference to FIG. 1, the horizontal component of the electric field is formed by the cut-out portions 71a and 71b of the common electrode 270, the first and second edges 195a and 195b parallel to the gate lines 121 of the first and second sub-pixel electrodes 191a and 191b, the third and fourth edges 195c and 195d parallel to the data lines 171, and the round corners 196. Accordingly, the liquid crystal molecules 31 are tilted in a direction perpendicular to a contact line of the circular cut-out portions 71a and 71b. In this manner, by varying the direction in which the liquid crystal molecules 31 are tilted, the reference viewing angle of the LCD can increase.

At least one of the cut-out portions 71a and 71b can be replaced with a protrusion (not shown) or a depressed portion (not shown). The protrusion can be made of an organic material or an inorganic material, and can be disposed above or below the field generating electrodes 191 and 270.

Electric field distortion may occur at the connection portion 193 between the first and second electrodes 191a and 191b, causing liquid crystals positioned at the connection portion to align in arbitrary directions such that they collide with each other. In embodiments of the present invention, however, because the length (L) of the connection portion 193 is sufficiently long and the width (W) thereof is sufficiently narrow, the influence of the electric field distortion occurring at the connection portion 193 on the liquid crystal molecules 31 can be minimized. Thus, the liquid crystal molecules 31 are not aligned in arbitrary directions and generation of an instant residual image due to collision of liquid crystals can be prevented.

In addition, since the storage electrode lines 131 are disposed to overlap with the connection portion 193 of the first and second sub-pixel electrodes 191a and 191b, and the contact holes 185a and 185b that connect the pixel electrode 191 and the drain electrode 175 are disposed between the first and second sub-pixel electrodes 191a and 191b, the overall aperture ratio of the pixels can be maximized.

Further, a stepped portion is formed due to the contact holes 185a and 185b in the passivation layer 180. When the connection portion 193 of a pixel electrode 191 is positioned at an upper portion of the stepped portion, the connection portion 193 may be disconnected. Thus, in order to prevent a possible disconnection of the first and second sub-pixel electrodes 191a and 191b due to the stepped portion of the passivation layer 180, in embodiments of the present invention, the contact holes 185a and 185b are formed at the branch portions 194a and 194b extending from the connection portion 193.

According to embodiments of the present invention, liquid crystal molecules that may not be affected by the fringe field can be minimized, a residual image caused by the collision of liquid crystals can also be minimized, and the aperture ratio of the LCD can be maximized.

While this invention has been described in connection with exemplary embodiments, it is to be understood that the invention is not limited to the disclosed embodiments, but is intended to cover various modifications and equivalent arrangements included within the spirit and scope of the appended claims.

What is claimed is:

1. A liquid crystal display (LCD) comprising:
a first substrate; and
a pixel electrode formed on the first substrate and comprising first and second sub-pixel electrodes,
wherein the first and second sub-pixel electrodes are connected to each other via a connection portion, and a length of the connection portion is greater than or equal to about 10 μm or larger.

2. The LCD of claim 1, wherein the length of the connection portion is within the range of about 20 μm to about 28 μm.

3. The LCD of claim 1, wherein a width of the connection portion is less than or equal to about 10 μm or smaller

4. The LCD of claim 3, wherein the width of the connection portion is within the range of about 6 μm to about 7 μm.

5. The LCD of claim 1, further comprising a storage electrode formed between the first and second sub-pixel electrodes.

6. The LCD of claim 5, further comprising:
a gate line formed on the first substrate;
a data line crossing the gate line and comprising a source electrode; and
a drain electrode facing the source electrode,
wherein the drain electrode and the storage electrode overlap each other.

7. The LCD of claim 6, wherein the pixel electrode and the drain electrode are electrically connected at a portion where the storage electrode and the drain electrode overlap.

8. The LCD of claim 7, further comprising a branch portion that extends from the connection portion, and the pixel electrode and the drain electrode are electrically connected at a portion where the branch portion overlaps the drain electrode.

9. The LCD of claim 8, wherein the branch portion comprises a first branch portion at a right side with respect to the connection portion and a second branch portion at a left side with respect to the connection portion.

10. The LCD of claim 9, further comprising a first contact hole that overlaps the first branch portion and a second contact hole that overlaps the second branch portion.

11. The LCD of claim 1, wherein the first and second sub-pixel electrodes have rounded corners.

12. The LCD of claim 1, further comprising:
a second substrate facing the first substrate; and
a common electrode formed on the second substrate,
wherein a plurality of tilt control portions are formed on the common electrode, and each of the plurality of tilt control portions face the center of one of the first or second sub-pixel electrodes.

13. The LCD of claim 12, wherein the tilt control portions include circular cut-out portions.

14. The LCD of claim 12, further comprising a light blocking member formed on the second substrate, wherein the light blocking member overlaps a gate line formed on the first substrate.

15. The LCD of claim 1, wherein an area of the first sub-pixel electrode and an area of the second sub-pixel electrode are substantially the same.
